(19) United States
(12) Patent Application Publication
(10) Pub. No.: US 2015/0130759 A1
(43) Pub. Date: May 14, 2015

(54) DISPLAY APPARATUS, VEHICLE EQUIPPED WITH THE DISPLAY APPARATUS AND CONTROL METHOD FOR THE DISPLAY APPARATUS

(71) Applicant: HYUNDAI MOTOR COMPANY, Seoul (KR)

(72) Inventor: Jong Hyuck HEO, Yongin-si (KR)

(73) Assignee: HYUNDAI MOTOR COMPANY

(21) Appl. No.: 14/537,600

(22) Filed: Nov. 10, 2014

(30) Foreign Application Priority Data
Nov. 11, 2013 (KR) 10-2013-0136517

(51) Int. Cl. B60R 1/00; G06F 3/0482; G06F 3/041; G06F 3/0488; G06F 3/044

(52) U.S. Cl. CPC B60R 1/00; G06F 3/0488; G06F 3/044; G06F 3/0412; G06F 3/0416; G06F 3/0482; G06F 2203/04101
USPC 345/174

(57) ABSTRACT

A display apparatus of a vehicle for providing various kinds of information includes a touchscreen unit to display at least one of a screen of an external manipulation mode and a screen of a touch manipulation mode, and a sensing unit to sense approach of an object to the touchscreen unit. The touchscreen unit displays the screen of the touch manipulation mode when the sensing unit senses approach of the object, and displays the screen of the external manipulation mode when the sensing unit does not sense approach of the object.

### CROSS-REFERENCE TO RELATED APPLICATION(S)

This application claims the benefit of priority to Korean Patent Application No. 2013-0136517, filed on Nov. 11, 2013 in the Korean Intellectual Property Office, the disclosure of which is incorporated herein by reference.

### TECHNICAL FIELD

The present invention relates to a display apparatus, a vehicle equipped with the display apparatus, and a control method for the display apparatus.

### BACKGROUND

In general, a vehicle is equipped with various apparatuses and is able to transport humans, objects, or animals from a departure point to a destination. The vehicles may include: a vehicle traveling on the road or rails; a ship moving on the sea or rivers; and an aircraft flying in the sky by the air. The vehicle may move in one direction according to rotation of at least one wheel. Such a vehicle may include: for example, a three-wheeled or four-wheeled vehicle; construction equipment; a two-wheeled vehicle; a motorcycle; a bicycle; and a train traveling on the rails.

A display apparatus providing various kinds of information may be provided at a driver's seat side. The display apparatus may provide information about a path between the departure point and the destination and/or information about the current location of the vehicle. In addition, the display apparatus may provide music or a moving image, or may receive and display terrestrial broadcasting or satellite broadcasting. The display apparatus may also provide information about the vehicle condition and/or weather and news.

### SUMMARY

An aspect of the present disclosure provides a display apparatus for a vehicle, which may be manipulated in a proper manner by a user according to situations and a control method for the display apparatus.

Another aspect of the present disclosure provides a display apparatus for a vehicle, which may be safely manipulated when a driver is driving the vehicle and may be easily and quickly manipulated even when the vehicle is not traveling and a control method for the display apparatus.

Additional aspects of the invention will be set forth in part in the description which follows and, in part, will be obvious from the description, or may be learned by practice of the invention.

In accordance with an exemplary embodiment of the present disclosure, a display apparatus includes a touchscreen to display at least one of a screen of an external manipulation mode and a screen of a touch manipulation mode. A sensor senses an object approaching the touchscreen. The touchscreen displays the screen of the touch manipulation mode when the sensor senses the object and displays the screen of the external manipulation mode when the sensor does not sense the object.

The display apparatus may further include an input provided with at least one of a physical button and a knob. The physical button unit and knob unit are adapted to receive user manipulation.

When the input is manipulated, the touchscreen may display the screen of the external manipulation mode.

The touchscreen may display a screen divided into a plurality of sections.

The touchscreen may display a map in at least two sections of the plurality of sections in the external manipulation mode, and display the map in at least one section of the plurality of sections in the touch manipulation mode.

The map may be a two-dimensional map or a three-dimensional map.

The touchscreen may display a three-dimensional map in the external manipulation mode and display a two-dimensional map in the touch manipulation mode.

The touchscreen may display at least one selectable menu in at least one section of the plurality of sections in the external manipulation mode and display at least one selectable menu in at least two sections of the plurality of sections in the touch manipulation mode.

At least one of the at least one selectable menu may be selected according to at least one physical button and at least one knob in the external manipulation mode.

The touchscreen may display at least one scrollable selectable menu in at least one section of the plurality of sections in the external manipulation mode or display a plurality of selectable menus in at least one section of the plurality of sections in the touch manipulation mode.

The touchscreen may display information corresponding to at least one physical button in at least one section of the plurality of sections according to manipulation of the physical button.

The touchscreen may display at least one selectable menu represented by a button-shaped image in the touch manipulation mode.

The touchscreen may display a selectable menu represented by an enlarged image in the touch manipulation mode.

The touchscreen may display at least one different selectable menu according to content to be displayed.

The sensor may further sense an approach direction of the object, and the touchscreen may display the screen of the touch manipulation mode according to the approach direction of the object sensed by the sensor.

In accordance with another exemplary embodiment of the present disclosure, a method of controlling a display apparatus which includes a touchscreen to display at least one of a screen of an external manipulation mode and a screen of a touch manipulation mode. The method may include a determination operation of determining presence of an object. A screen display operation of the touchscreen displays the screen of the touch manipulation mode upon determining that the object is present and displaying the screen of the external manipulation mode upon determining that the object is not present.

The screen display operation may include the touchscreen displaying the screen of the external manipulation mode when manipulation of an external input installed at or connected to the display apparatus is sensed.

At least one of the screen of the external manipulation mode and the screen of the touch manipulation mode may be divided into a plurality of sections.

The determination operation may include sensing an approach direction of the object. The screen display operation may include displaying the screen of the touch manipulation mode according to the sensed approach direction of the object.

In accordance with another exemplary embodiment of the present disclosure, a vehicle equipped with a display apparatus may include a sensor configured to sense proximity of an object. A touchscreen displays a screen of at least one of an external manipulation mode and a touch manipulation mode. The touchscreen displays the screen of the touch manipulation mode when the sensor senses proximity of the object.

The vehicle may further include a controller to determine whether the vehicle is traveling. The touchscreen may display the screen of the external manipulation mode.

The sensor may further sense a location of a user. The touchscreen may display the screen of the touch manipulation mode according to the location of the user sensed by the sensor.

The touchscreen may display the screen of the touch manipulation mode when the location of the user is near a front passenger seat.

### BRIEF DESCRIPTION OF THE DRAWINGS

These and/or other aspects of the invention will become apparent and more readily appreciated from the following description of the embodiments, taken in conjunction with the accompanying drawings.

FIG. 1 is a block diagram illustrating a display apparatus according to an exemplary embodiment of the present disclosure.

FIGS. 2 and 3 are a plan view and a perspective view illustrating an input according to an exemplary embodiment of the present disclosure.

FIG. 4 is a block diagram illustrating an internal structure of a vehicle according to an exemplary embodiment of the present disclosure.

FIG. 5 is a view illustrating a touchscreen and a sensor according to an exemplary embodiment of the present disclosure.

FIG. 6 is a view illustrating operation of a sensing unit according to an exemplary embodiment of the present disclosure.

FIGS. 7A and 7B are views illustrating display screens displayed on a touchscreen in the case that selection of a function of the display apparatus is performed in an external manipulation mode according to various embodiments.

FIG. 8A is a view illustrating a display screen displayed on the touchscreen in the case that selection of a function of the display apparatus is performed in a touch manipulation mode according to an exemplary embodiment of the present disclosure.

FIG. 8B is a view illustrating a screen displayed during change from the screen of the external manipulation mode to the screen of the touch manipulation mode according to an exemplary embodiment of the present disclosure.

FIG. 9 is a view illustrating a process of expansion of an image displayed in some section of a touchscreen according to an exemplary embodiment of the present disclosure.

FIG. 10 is a view illustrating change of a map displayed on a touchscreen according to an exemplary embodiment of the present disclosure.

FIG. 11 is a view illustrating a display screen displayed on the touchscreen in the case that the navigation function of the display apparatus is performed in the external manipulation mode according to an exemplary embodiment of the present disclosure.

FIG. 12 is a view illustrating a display screen displayed on the touchscreen in the case that the navigation function of the display apparatus is performed in the touch manipulation mode according to an exemplary embodiment of the present disclosure.

FIG. 13 is a view illustrating a display screen displayed on the touchscreen in the case that the application execution function of the display apparatus is performed in the external manipulation mode according to an exemplary embodiment of the present disclosure.

FIG. 14 is a view illustrating a display screen displayed on the touchscreen in the case that the application execution function of the display apparatus is performed in the touch manipulation mode according to an exemplary embodiment of the present disclosure.

FIG. 15 is a view illustrating a display screen displayed on the touchscreen in the case that the sound file reproduction function of the display apparatus is performed in the external manipulation mode according to an exemplary embodiment of the present disclosure.

FIG. 16 is a view illustrating a display screen displayed on the touchscreen in the case that the sound file reproduction function of the display apparatus is performed in the touch manipulation mode according to an exemplary embodiment of the present disclosure.

FIGS. 17 to 18B are views illustrating a display screen displayed to allow convenient input of characters in the external manipulation mode and the touch manipulation mode according to an exemplary embodiment of the present disclosure.

FIGS. 19 and 20 are views illustrating a method for a sensor to sense users.

FIG. 21 is a flowchart illustrating a method of controlling a display apparatus according to an exemplary embodiment of the present disclosure.

### DETAILED DESCRIPTION

Reference will now be made in detail to embodiments of the present disclosure, examples of which are illustrated in the accompanying drawings, wherein like reference numerals refer to like elements throughout.

In describing a display apparatus and a method of controlling a display apparatus according to an exemplary embodiment, it is assumed the display apparatus is installed in an automobile. However, embodiments of the present invention are not limited thereto. The display apparatus may also be installed at other kinds of vehicles, for example, two-wheeled vehicles such as a motorcycle, a motorized bicycle or a bicycle, and various kinds of construction equipment.

The display apparatus may include a navigation device installed in a vehicle. In addition, the display apparatus may include a portable terminal such as a smartphone or a tablet. The display apparatus may also include various kinds of display apparatuses that may be used in a vehicle and display images.

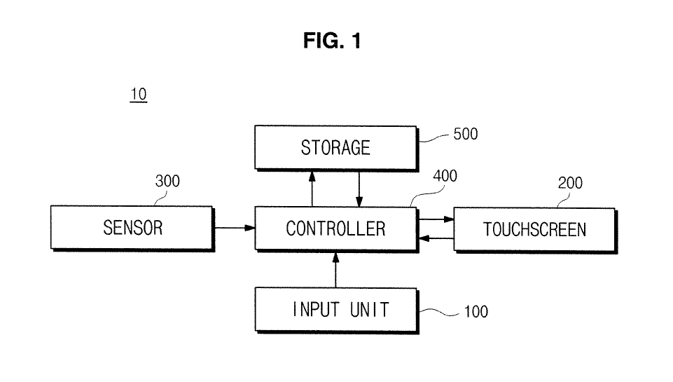

Hereinafter, a description will be given of a vehicle equipped with a display apparatus with reference to FIGS. 1 to 6. FIG. 1 is a block diagram illustrating a display apparatus according to an exemplary embodiment.

Referring to FIG. 1, a display apparatus 10 may include at least one of an input 100, a touchscreen 200, a sensing unit 300, a controller 400, and a storage 500.

The input 100 may receive a predetermined instruction or command from a user according to manipulation by the user, produce an electrical signal corresponding to the received instruction or command, and then transfer the produced electrical signal to the controller 400.

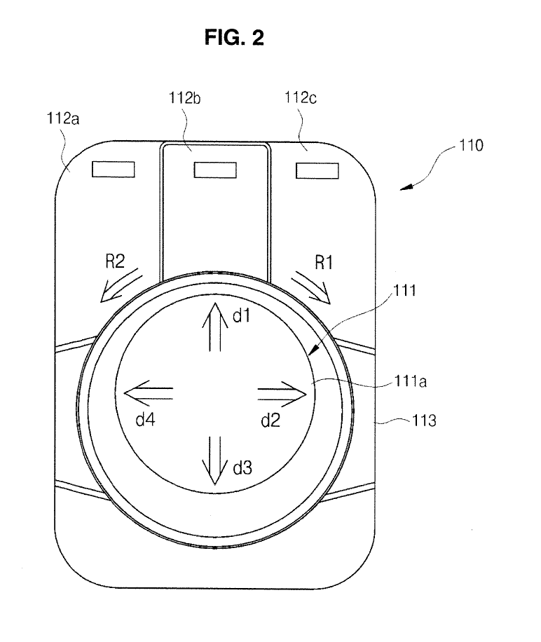

FIG. 2 is a plan view illustrating an input 100 according to the embodiment. The input 100 according to the embodiment may include a dial manipulator 110 as shown in FIG. 2. Referring to FIG. 2, the dial manipulator 110 may include a knob unit 111, physical buttons 112a to 112c, and a housing 113.

The knob unit 111 may include a knob 111a which is rotatable in at least one direction and various components supporting operation of the knob 111a. The knob 111a may rotate about a predetermined axis of rotation in a clockwise direction R1 or in a counterclockwise direction R2. The knob 111a may be formed of metal, synthetic resin, or a compound. A handle (not shown) may be formed on the outer surface of the knob 111a to allow the user to easily grip the knob 111a. The handle may be formed of metal, rubber, or synthetic resin.

According to an embodiment, the knob 111a may be tilted with respect to a central axis in at least one direction d1 to d4. For example, the knob 111a may be tilted in up and down directions d1 and d3 and left and right directions d2 and d4, as shown in FIG. 2. While the knob 111a is illustrated in FIG. 2 as being tilted in the up, down, left, and right directions d1 to d4, the direction of tilt of the knob 111a is not limited thereto. The knob 111a may also be tilted in various directions such as an upper left direction (a direction between d1 and d2) or a lower left direction (a direction between d2 and d3).

The user may manipulate the knob 111a by rotating or tilting the knob 111a in a specific direction to input a predetermined instruction or command.

The physical buttons 112a to 112c may receive a predetermined input from the user when the user applies pressure thereto. The physical buttons 112a to 112c may be installed at the housing 113, as shown in FIG. 2. The physical buttons 112a to 112c may be formed around the knob 111a. Each physical button 112a to 112c may be assigned to a different function to be executed. For example, a first physical button 112a inputs a command to execute an application for reproduction of a multimedia file, a second physical button 112b inputs a command to execute a navigation application, and a third physical button 112c inputs a command to execute any of various other applications. By manipulating the buttons 112a to 112c, the user may control various devices in the vehicle having the display apparatus 10. When the physical buttons 112a to 112c are subjected to pressure applied by the user, they may respectively produce an electrical signal and transfer the produced signal to the controller 400.

In some embodiments, the physical buttons may be formed at the knob 111a. According to one embodiment, the physical buttons may be formed on an upper surface of the knob 111a. According to another embodiment, the knob 111a itself may perform the functions of the physical buttons. For example, the knob 111a may be designed to move toward or away from the housing 113. In this case, the user may move the knob 111a toward the housing 113 by applying pressure to the knob 111a, thereby inputting the predetermined instruction or command as in the case in which the physical buttons are used.

The housing 113 may be equipped with various components supporting the knob 111a of the knob unit 111 or related to operation of knob 111a. A rotation axis member to which the knob 111a is coupled to rotate about a predetermined axis of rotation, various members allowing the knob 111a to tilt in a specific direction, and various relevant components may be installed in the housing 113. In addition, at least one semiconductor chip, a switch, an integrated circuit, a resistor, and a printed circuit board (PCB) may be installed in the housing 113. The semiconductor chip, the switch, the integrated circuit, or the resistor may be installed on the PCB in the housing 113. The at least one semiconductor chip may process information or store data. The at least one semiconductor chip may interpret an electrical signal produced according to movement of the knob 111a or manipulation of a button formed at the knob 111a, produce a control signal according to the interpreted content, and then transfer the control signal to the controller 400 or the touchscreen 200. In one embodiment, the controller 400 shown in FIG. 1 may be provided with at least one semiconductor chip installed in the housing 113.

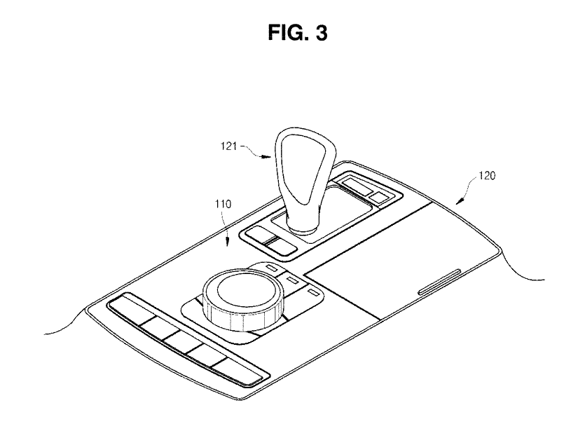

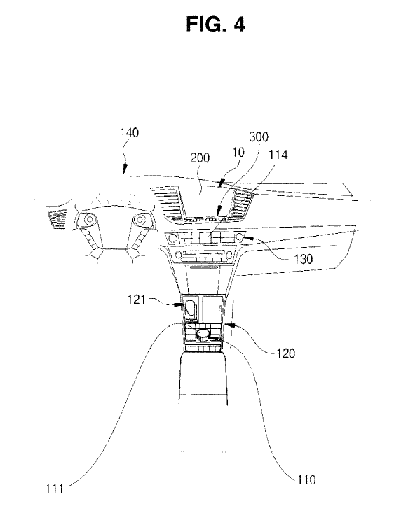

FIG. 3 is a perspective view illustrating a dial manipulation device according to an embodiment of the present disclosure. FIG. 4 is a block diagram illustrating an internal structure of a vehicle according to an embodiment of the present disclosure.

As shown in FIGS. 3 and 4, a dial manipulation device 110 may be installed at a gear box 120. A transmission gear 121 to change speed of the vehicle may be installed in the gear box 120. In the case that the dial manipulation device 110 is installed at the gear box 120, various components associated with the dial manipulation device 110, at least one semiconductor chip and a PCB may be installed in the gear box 120. According to another embodiment, a dial manipulation device 114 may be formed at a center fascia 130 provided on a dashboard. According to one embodiment, the dial manipulation devices 110 and 114 may be installed at both the gear box 120 and the center fascia 130. Each of the dial manipulation devices 110 and 114 may separately receive an instruction or command from the user.

The dial manipulation device 110 has been described above as an example of the input unit 100. However, the input unit 100 is not limited to the dial manipulation device 110. It may include various input elements for manipulation of the display apparatus 10. The input elements may include, for example, a touch pad, a track ball, various stick-shaped manipulation devices, and various buttons. For example, the user may manipulate the touch pad by touching the touch pad or applying a predetermined touch gesture to the touch pad. In this case, the user may input a predetermined instruction or command corresponding to a touch manipulation, the predetermined command input by the user may be transferred to the controller 400.

Various input elements as described above may be arranged at various positions in the vehicle. For example, the input elements may be provided to the gear box 120, the center fascia 130, a steering wheel 140 (see FIG. 4), or the housing 220 of the touchscreen 200 of the display apparatus 10.

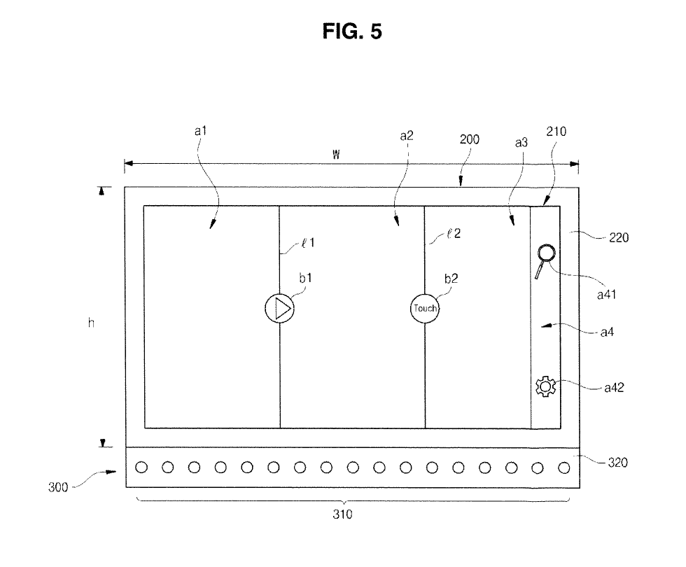

FIG. 5 is a view illustrating a touchscreen unit and a sensing unit according to one embodiment.

The touchscreen 200 may display at least one screen and at the same time receive a predetermined instruction or command from the user according to touch manipulation by the user. According to one embodiment, the touchscreen 200 may display at least one of a screen of an external manipulation mode and a screen of a touch manipulation mode.

The screen of the external manipulation mode indicates a screen displayed on the display part 210 of the touchscreen 200 when the user inputs the predetermined instruction or command by manipulating the input 100, e.g., the dial manipulation device 110. According to one embodiment, the touchscreen 200 may display the screen of the external manipulation mode when the sensing unit 300 does not sense an object. In this case, the screen of the external manipulation mode may be set to be the default screen of the sensing unit 300. According to another embodiment, the touchscreen 200 may display the screen of the external manipulation mode when the input 100 is manipulated.

The screen of the touch manipulation mode indicates a screen that is displayed on the display part 210 of the touchscreen 200 when touch manipulation is performed on the display part 210 of the touchscreen 200. The touchscreen 200 may display the screen of the touch manipulation mode when the sensing unit 300 senses an object. The screen of the touch manipulation mode may include images of various touch buttons and a scroll which allows the user to perform touch manipulation. The screen of the touch manipulation mode may further include a handwriting input window allowing handwriting to be input using various touch tools such as a touch pen and fingers. The screen of the touch manipulation mode may include buttons larger than those displayed on the screen of the external manipulation mode, in order to allow the user to conveniently perform touch manipulation.

Referring to FIG. 4, the touchscreen 200 may be installed on a center fascia of a dashboard. However, the location where the touchscreen 200 is installed is not limited thereto. It may be installed at any location in the vehicle as selected by the system designer or the user. In one embodiment, the touchscreen 200 may be embedded in the dashboard such that only the display part 210 to display a touch-manipulated screen is exposed. In addition, the touchscreen 200 may be separately mounted at an exterior of the dashboard. In this case, the display part 210 and the touchscreen 200 may be exposed together.

The touchscreen 200 may employ a resistive touchscreen which senses the user's touch manipulation by recognizing pressure or a capacitive touchscreen which senses the user's touch manipulation based on the effect of capacitive coupling. In addition, the touchscreen 200 may employ an optical touchscreen which uses infrared light or an ultrasonic touchscreen which uses ultrasound.

The touchscreen 200 may include the display part 210 to display a predetermined screen. The display part 210 may be implemented by combining a touch panel with a liquid crystal display (LCD) panel, a light emitting diode (LED) panel, or an organic light emitting diode (OLED) panel.

The display part 210 may display a display screen a and includes a predetermined image. An aspect ratio (w:h) of the display screen a displayed by the display part 210 may be 4:3, 16:9, or 21:9. The aspect ratio (w:h) of the display screen a may be determined by the manufacturer. The size of the display screen a may be determined as desired. For example, the size of the display screen a may have any value between 7 inches and 9 inches. It may also be possible that the size of the display screen a is outside this range.

Referring to FIG. 5, the display screen a displayed on the display part 210 may be divided into a plurality of sections a1 to a4. For example, the display part 210 may be divided into four sections a1 to a4, as shown in FIG. 5. Some of the sections a1 to a4, e.g., the sections a1 to a3 may display images related to various functions provided by the display apparatus 10. The other section, e.g., the section a4 may display various function keys to input auxiliary commands. At least one division line 11, 12 to clearly distinguish the sections a1 and a2 may be further displayed between the sections a1 to a4.

According to one embodiment, the sections a1 to a4 of the display screen a displayed by the display part 210 may display different images. For example, the first section a1 may display a navigation map, the second section a2 may display selectable menus and various kinds of information related to the navigation function, and the third section a3 may display an execution screen for a multimedia reproduction application. According to one embodiment, the plurality of sections a1 to a4, e.g., the first section a1 and the second section a2 may display one image together. For example, the navigation map may be displayed throughout the first section a1 and the second section a2, and related information and selectable menus may be displayed in the third section a3. In the display screen a, the sections a1 to a3 to display images related to various functions provided by the display apparatus 10 may correspond respectively to the physical buttons of the input 100, e.g., the first to third physical buttons 112a to 112c. For example, when the user manipulates the first physical button 112a, the first section a1 on the display screen a corresponding to the first physical button 112a may be controlled. In this case, predetermined information corresponding to the first physical button 112a may be displayed in the first section a1 on the display screen a corresponding to the first physical button 112a. For example, in the case that the first physical button 112a is assigned to driving of the multimedia reproduction application, the multimedia reproduction application may be driven according to manipulation of the first physical button 112a, and a skin image of the multimedia reproduction application may be displayed in the first section a1. The sizes of the sections a1 to a3 may be changed through manipulation of the physical buttons. For example, when the first physical button 112a is manipulated, the first section a1 may be enlarged. In the case that the first section a1 is enlarged, the second section a2 and the third section a3 may be displayed in reduced sizes or may not be displayed.

According to one embodiment, one of the sections a1 to a4, for example, the section a4 may display various icons a41 and a42 to receive auxiliary commands. The icons may include a search icon a41 and a setting icon a42. The search icon a41 may be a link that calls a search application to search for various data or functions stored in the storage 500 of the display apparatus 10. The setting icon a42 may be a link that calls a setting change application to change settings of the display apparatus 10.

According to one embodiment, an indication image b to indicate the current manipulation mode may be displayed on the division lines 11 and 12 that distinguish the sections a1 to a4 from each other. The indication image b may be one of plural indication images b1 and b2 corresponding to manipulation modes that may be set. For example, the indication image b may be a first indication image b1 to indicate that the external manipulation mode is executed. In addition, the indication image b may be a second indication image b2 to indicate that the touch manipulation mode is executed. A sign related to an external input may also be displayed on the first indication image b1, and a sign related to touch manipulation may be also displayed on the second indication image b2. For example, a “Touch” sign may be displayed on the second indication image b2. While FIG. 5 illustrates that both first indication image b1 and second indication image b2 are displayed, only one of the first indication image b1 and the second indication image b2 may be displayed. In the case that different modes, e.g., the external manipulation mode and the touch manipulation mode are not allowed to be simultaneously executed, the first indication image b1 and the second indication image b2 may be displayed on the display screen a together.

The indication image b may be the point that is touched in the touch manipulation to move the division line 12 distinguishing plural sections from each other. For example, the second indication image b2 may be a point that a touch tool such as the user's finger touches in touch manipulation to move the division line 12 distinguishing the second section a2 and the third section a3 from each other. The user may move the division line 12 by touching the second indication image b2 and performing a dragging operation in a predetermined direction, e.g., a left direction or a right direction. When the division line 12 is moved, the size of one section, for example, the second section a2 or the third section a3 may be increased, and another section may be downsized or may not be displayed. Accordingly, the sizes of at least two sections of the sections a1 to a4 may be changed, or at least one section of the sections a1 to a4 may not be displayed on the screen.

The touchscreen 200 may include a housing 220 to fix the display part 210 and install various components related to the display part 210. A PCB and various semiconductor chips to control the display part 210 may be installed in the housing 220. The semiconductor chips and the PCB may perform the functions of the controller 400 shown in FIG. 1. According to one embodiment, at least one physical button may be formed at the exterior of the housing 220. The at least one physical button formed at the exterior of the housing 220 may be an example of the input 100.

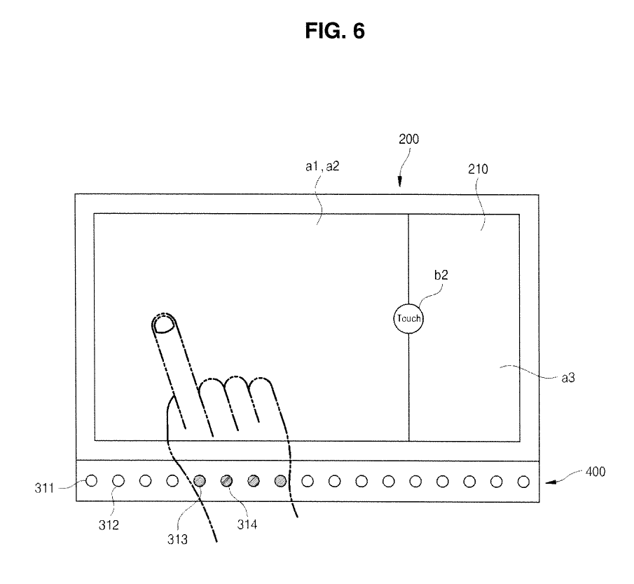

FIG. 6 is a view illustrating operation of a sensing unit according to one embodiment.

Referring to FIG. 1, the display apparatus 10 may include a sensing unit 300. The sensing unit 300 may sense an object approaching, e.g., a user's finger or a touch pen that approaches the touchscreen 200. The sensing unit 300 may be formed around the touchscreen 200 as shown in FIGS. 4 to 6. According to one embodiment, the sensing unit 300 may be installed behind the touchscreen 200 as shown in FIGS. 5 and 6. In addition, the sensing unit 300 may be installed next to the touchscreen 200. The sensing unit 300 may be installed at upper, lower, left, and right portions of the touchscreen 200. The sensing unit 300 may be installed only at some of the upper, lower, left, and right portions of the touchscreen 200, as shown in FIGS. 5 and 6.

As shown in FIGS. 5 and 6, the sensing unit 300 may include at least one sensor 310 and a sensor installation part 320 on which the sensor 310 is installed.

The sensor 310 may sense the approach or presence of an object around the sensor 310. The sensor 310 may be a motion sensor. According to one embodiment, the motion sensor may receive electromagnetic waves, e.g., microwaves radiated and reflected on an object and compare the radiated electromagnetic waves with the received electromagnetic waves to sense the presence or motion of the object. According to another embodiment, the motion sensor may sense heat rays resulting from body heat of a human body, i.e., infrared light and then output a predetermined electrical signal according to the sensed infrared light to sense existence or motion of the object. According to another embodiment, the motion sensor may sense existence, motion, or shape of a foreign object by sensing light. Examples of the sensor 310 may include various kinds of sensors capable of sensing motion of a human body or presence of a touch manipulation tool.

The sensor installation part 320 allows the sensor 310 to be stably fixed around the touchscreen 200. According to one embodiment, the sensor installation part 320 may include at least one frame and at least one exterior cover fixed to the frame (not shown). The frame may be formed of metal or synthetic resin, and the sensor installation part 320 may be seated at the frame. The exterior cover may protect the sensor 310. The exterior cover may be formed of a transparent or semi-transparent material.

In the case that a predetermined object, e.g., a user's hand or a touch pen approaches the screen of the touchscreen 200, at least one of the touch sensors 310 of the sensing unit 300, for example, a third sensor 313 and a fourth sensor 314 may sense the approach of an object using infrared light or electromagnetic waves. Once the object is sensed, the sensors, for example, the third sensor 313 and the fourth sensor 314 which have sensed the object may output a predetermined electrical signal according to the sensing and transfer the signal to the controller 400.

The controller 400 may control overall operations of the display apparatus. According to one embodiment, the controller 400 may produce a predetermined control signal based on an electrical signal transferred from the input unit 100 and transfer the produced control signal to the touchscreen 200.

In addition, the controller 400 may control a screen displayed on the touchscreen 200 by producing a predetermined control signal based on an electrical signal transferred from the sensing unit 300 and by transferring the produced control signal to the touchscreen 200. Specifically, the controller 400 may interpret the electrical signal transferred from the sensing unit 300 and determine whether the object approaches or exists. The controller 400 may produce a control signal for the display screen a of the touchscreen 200 according to the result of the determination and transfer the produced control signal to the touchscreen 200.

According to one embodiment, when the sensing unit 300 senses the approach or presence of an object, such as the user's hand, and outputs an electrical signal as shown in FIG. 6, the controller 400 may determine that an object is present around the display part 210 of the touchscreen 200. Upon determining that the object is present, the controller 400 may produce a control signal instructing the touchscreen 200 to display the screen of the touch manipulation mode and transfer the produced control signal to the touchscreen 200. In the case that the sensing unit 300 does not sense any object, the controller 400 may determine that no object is present around the display part 210. In this case, the controller 400 may produce a control signal instructing the touchscreen 200 to display the screen of the external manipulation mode and transfer the produced control signal to the touchscreen 200. According to one embodiment, in the case that the sensing unit 300 does not sense any object, the controller 400 may not produce any separate control signal. In this case, the touchscreen 200 may be basically set to display the external display mode when a separate control signal for a manipulation mode is not transferred from the controller 400 to the touchscreen 200. According to one embodiment, in the case that the input 100 is manipulated, and thus, the electrical signal is transferred from the input 100 to the controller 400, the controller 400 may determine that the input unit 100 has been manipulated by the user. Then, the controller 400 may produce a control signal instructing the touchscreen 200 to display the screen of the external manipulation mode and transfer the control signal to the touchscreen 200. The touchscreen 200 may display a screen of at least one of the external manipulation mode and the touch manipulation mode according to the received control signal.

According to one embodiment, the controller 400 may determine whether the vehicle is traveling by using various devices in the vehicle. For example, the controller 400 may determine whether the vehicle is traveling based on change in location coordinates of the vehicle by using a global positioning system. The controller 400 may also determine whether the vehicle is traveling depending upon whether the wheels of the vehicle are rotating. In the case that the vehicle is traveling, the controller 400 may control the touchscreen 200 to display only the screen of the external manipulation mode. In the case that the vehicle is not traveling, the controller 400 may control the touchscreen 200 to display the screen of the touch manipulation mode. In the case that the vehicle is not traveling and the sensing unit 300 senses an object, the touchscreen 200 may be controlled to display the screen of the touch manipulation mode.

The controller 400 may control the touchscreen 200 to display content such as various kinds of information and an application execution window on the screen according to the user's selection or pre-stored settings. The touchscreen 200 may be controlled to display at least one different selectable menu according to the screen-displayed content which is selected by the user or preset.

The controller 400 may be provided with at least one semiconductor chip or circuit or other components. According to one embodiment, the controller 400 may be provided with various semiconductors and circuits installed in the gear box 120. According to another embodiment, the controller 400 may be provided with various semiconductor chips and circuits installed on a PCB mounted in the housing 220. According to one embodiment, the controller 400 may be provided with an electronic control system (ECS) installed in the vehicle. In addition, the controller 400 may include a processor provided in a navigation device.

According to one embodiment, the controller 400 may call data for execution of an application or various information data such as multimedia file data and image data stored in the storage 500. Then, the controller 400 displays the called information data on the touchscreen 200, or executes the application and displays a corresponding application execution window on the touchscreen 200.

The storage 500 may store the various data and settings for implementation of various functions of the display apparatus 10. According to one embodiment, the storage 500 may store various maps or information related thereto and multimedia file data.

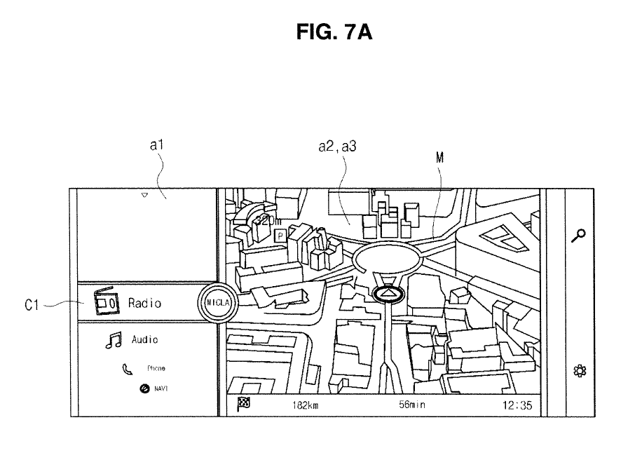

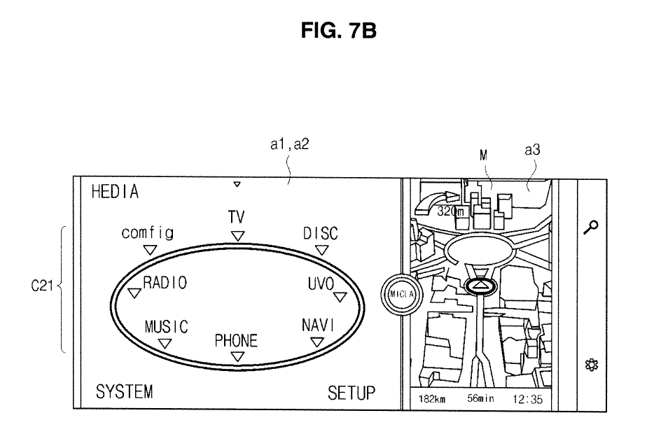

Hereinafter, the screen of the external manipulation mode and the screen of the touch manipulation mode will be described with reference to FIGS. 7A to 16.

FIGS. 7A and 7B are views illustrating display screens displayed on a touchscreen in the case that selection of a function of the display apparatus is performed in the external manipulation mode, according to various embodiments.

According to one embodiment as illustrated in FIG. 7A, in the case that the external manipulation mode is set, i.e. in the case that the user's instruction or command is input by manipulating the input 100, the display part 210 of the touchscreen 200 may display at least one selectable menu c1 in a section having a smaller size than the other sections of a plurality of sections a1 to a3, and display various kinds of information in the other sections having a larger size. For example, the display part 210 may display at least one selectable menu c1 related to various functions of the display apparatus in one of the sections a1 to a3, e.g. the first section a1, and display a predetermined image, a map M in the other sections, the second and third sections a2 and a3. The at least one selectable menu c1 displayed in the first section a1 may include an item for execution of a radio application, an item for execution of an sound reproduction application, an item for execution of a phone-call function, and an item for execution of a navigation function. A plurality of selectable menus c1 may be displayed in the first section a1 in a scrolling manner. In addition, the plurality of selectable menus c1 may move up or down according to manipulation by the user to allow the user to select one of the menus c1. The user may move the selectable menus c1 by rotating the knob 111a of the input 100 and select at least one among the selectable menus c1. The map M displayed in the second and third sections a2 and a3 may be a two-dimensional map or a three-dimensional map.

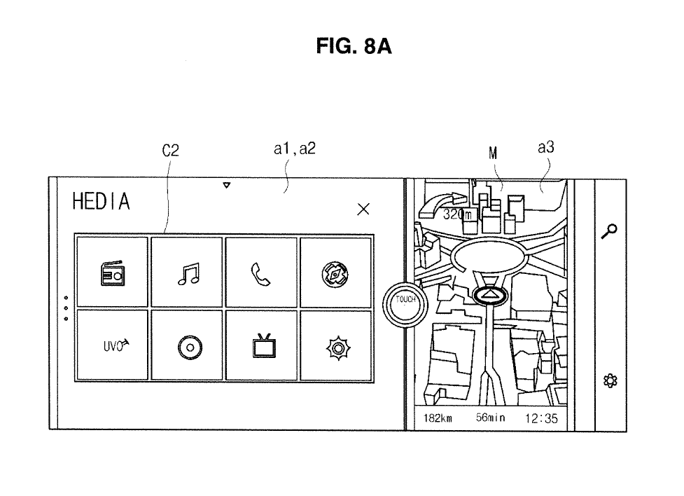

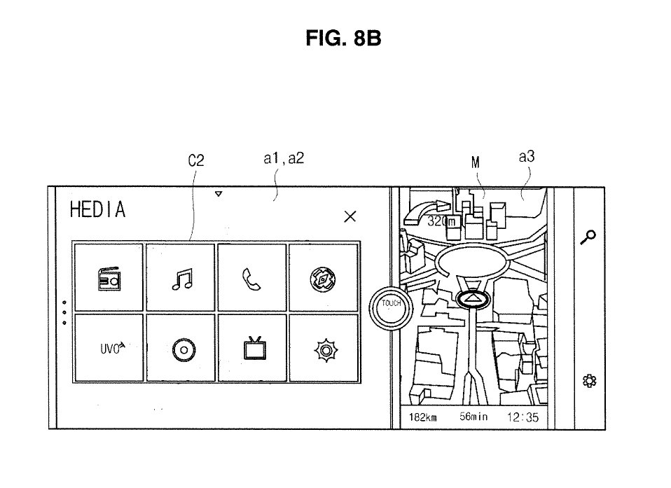

According to another embodiment as illustrated in FIG. 7B, in the case that the external manipulation mode is set, the display part 210 of the touchscreen 200 may display at least one selectable menu c21 in sections having a larger size than the other section of the sections a1 to a3, and display various kinds of information in the other section having a smaller size. For example, the display part 210 may display at least one selectable menu c21 related to various functions of the display apparatus in plural sections of the sections a1 to a3, e.g. the first and second sections a1 and a2, and display an image to provide various kinds of information, e.g., a map M in the other section, the third section a3. The at least one selectable menu c21 displayed in the first and second sections a1 and a2 may include an item for execution of a radio application, an item for execution of an sound reproduction application, an item for execution of a phone-call function, and an item for execution of a navigation function. The at least one selectable menu c21 may be disposed in a circular shape and displayed on the screen, or may be displayed in a oval shape and displayed on the screen as shown in FIG. 7B. According to one embodiment, when the user rotates the input 100, e.g., the knob 111 of the dial manipulation device 110, the at least one selectable menu c21 disposed in a circular or oval shape may also rotate in the direction in which the knob 111 is rotated. According to another embodiment, focus may be positioned on the at least one selectable menu c21 disposed in a circular or oval shape. Thereby, when the user rotates the input 100, e.g., the knob 111 of the dial manipulation device 110, the focus may be sequentially shifted along the at least one selectable menu c21 disposed in a circular or oval shape according to rotation of the knob 111. FIG. 8A is a view illustrating a display screen displayed on the touchscreen 200 in the case that selection of a function of the display apparatus is performed in a touch manipulation mode according to one embodiment.

In the case that the sensing unit 300 senses an object, e.g., the user's hand as shown in FIG. 6, the controller 400 may produce a predetermined control signal according to the sensing by the sensing unit 300 and transfer the signal to the touchscreen 200 to cause the touchscreen 200 to display the screen of the touch manipulation mode. Then, the touchscreen 200 may display the screen of the touch manipulation mode as shown in FIG. 8A. For example, as shown in FIG. 8A, the display part 210 may display at least one selectable menu c2 in sections having a larger size than the other section of the sections a1 to a3, e.g., the first and second sections a1 and a2 and display various kinds of information, e.g., a map M in the other section having a smaller size, the third section a3. The at least one selectable menu c2 displayed in the touch manipulation mode may be at least one guide image to guide the user's touch manipulation. The at least one guide image may be designed in the form of a predetermined button as shown in FIG. 8A. The at least one selectable menu c2 displayed in the touch manipulation mode may be selectable buttons of enlarged images larger than the image of the at least one selectable menu c1 displayed in the external manipulation mode. Thereby, the user is allowed to touch a selectable menu of a large size in touch manipulation, and accordingly may more easily select a desired selectable menu c2.

According to one embodiment, the display part 210 of the touchscreen 200 displays an image of the same kind in the same direction. For example, as shown in FIGS. 7A, 7B, and 8A, the images related to the selectable menus c1 and c2 may be displayed in the left sections, e.g., the first section a1 (FIG. 7A) or the first and second section a1 and a2 (FIGS. 7B and 8A) and another image, e.g., a screen image related to the map M, may be displayed in the right sections, the second and third sections a2 and a3 (FIG. 7A) or the third section a3 (FIGS. 7B and 8A). In this case, the images related to the selectable menus c1 and c2 may be prevented from causing user confusion by moving to completely different positions.

FIG. 8B is a view illustrating a screen displayed during change from the screen of the external manipulation mode to the screen of the touch manipulation mode according to one embodiment.

According to one embodiment, in the case that the screen of the external manipulation mode is changed to the screen of the touch manipulation mode or the screen of the touch manipulation mode is changed to the screen of the external manipulation mode, the screen may be changed according to a predetermined animation effect. For example, in the case that that the screen of the external manipulation mode shown in FIG. 7B is changed to the screen of the touch manipulation mode shown in FIG. 8A, the change may occur as the screen of the touch manipulation mode overlaps the screen of the external manipulation mode. In another case, the screen may be changed to the screen of the external manipulation mode as it overlaps the screen of the touch manipulation mode.

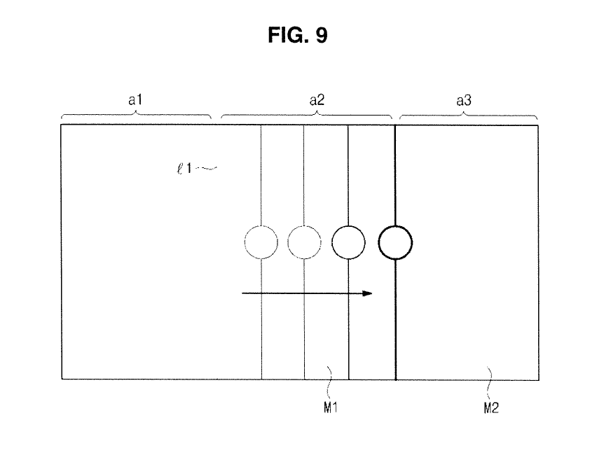

FIG. 9 is a view illustrating a process of changing the screen of a touchscreen according to one embodiment.

In the case that approach of an object is sensed while the touchscreen 200 displays the screen of the external manipulation mode of FIG. 7A, the touchscreen 200 may change the display screen to the screen of the external manipulation mode of FIG. 8A. In this case, change from the screen of the external manipulation mode to the screen of the touch manipulation mode may be implemented as a predetermined animation effect is displayed, as shown in FIG. 9. For example, the predetermined animation effect may include movement of the division line 11 from the boundary between the first section a1 and the second section a2 to the second section a2 and third section a3. Thereby, in place of a first map M1 displayed in the second and third sections a2 and a3, a second map M2 is displayed in the third section a3 on the display part 210. In this case, the second map M2 may display only a portion of the first map M1, e.g., a central portion of the first map M1.

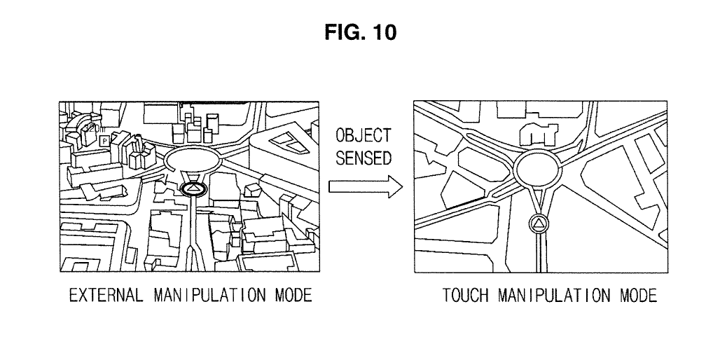

The touchscreen 200 may display different maps depending upon whether the mode is the external manipulation mode or the touch manipulation mode. FIG. 10 is a view illustrating change of a map displayed on a touchscreen according to one embodiment. For example, the touchscreen 200 may display a three-dimensional map in the second and third sections a2 and a3 in the external manipulation mode. When the sensing unit 300 senses an object, e.g., the user's hand, the touchscreen 200 may display the screen of the touch manipulation mode. In this case, the map in the touch manipulation mode may be a two-dimensional map. The touchscreen 200 may display the two-dimensional map in the second and third sections a2 and a3 or in the third section a3. In the case that the two-dimensional map is displayed on the screen of the touch manipulation mode, the user may more easily touch any point on the map.

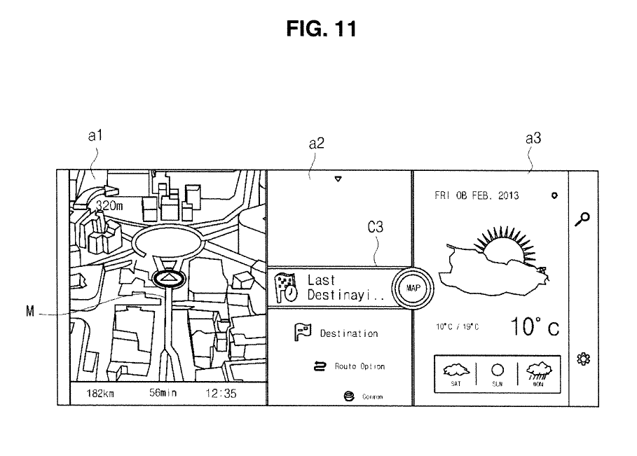

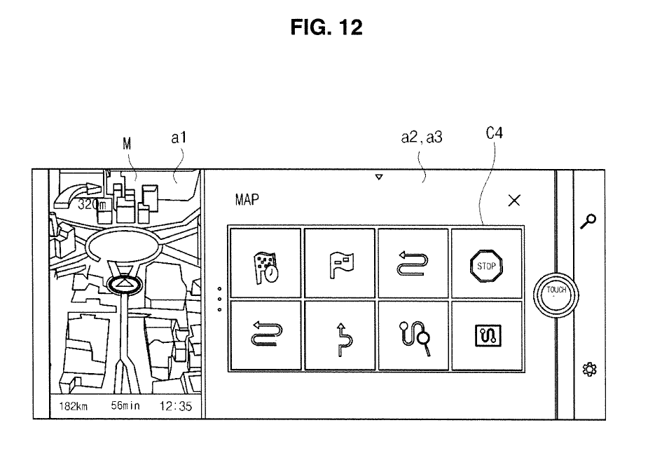

FIG. 11 is a view illustrating a display screen displayed on the touchscreen in the case that the navigation function of the display apparatus is performed in the external manipulation mode according to one embodiment. FIG. 12 is a view illustrating a display screen displayed on the touchscreen in the case that the navigation function of the display apparatus is performed in the touch manipulation mode according to one embodiment.

As shown in FIG. 11, in the case that the display apparatus 10 performs the navigation function, and the touchscreen 200 displays the screen of the external manipulation mode, the touchscreen 200 may display a two-dimensional or three-dimensional map M to guide a path in one of the sections a1 to a3, e.g., the first section a1. The touchscreen 200 may display various selectable menus c3 related to the map in another section, e.g., the second section a2. The selectable menus c3 are movable up and down. The user may select at least one selectable menu c3 from among the selectable menus c3 by moving the selectable menus c3. According to one embodiment, the touchscreen 200 may display information about, for example, weather and news which may be necessary for the user in the other section, e.g., the third section a3.

In the case that the sensing unit 300 senses an object and the touchscreen 200 displays the screen of the touch manipulation mode, the touchscreen 200 may display a two-dimensional or three-dimensional map M to guide a path in at least one of the sections a1 to a3, e.g., the first section a1, and display various selectable menus c4 related to the map in the other sections, e.g., the second and third sections a2 and a3. The selectable menus c4 may be displayed throughout the wider sections a2 and a3 in the touch manipulation mode than the second section a2 in the external manipulation mode. The selectable menus c4 displayed in the touch manipulation mode may be selectable buttons of larger images than the selectable menus c3 displayed in the external manipulation mode. Accordingly, the user may more accurately touch at least one of the selectable menus c4 displayed in the touch manipulation mode. As a result, the user may easily select at least one of the selectable menus c4.

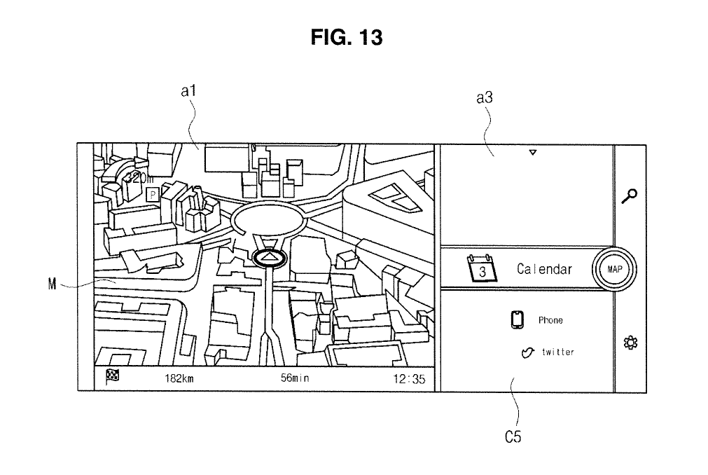

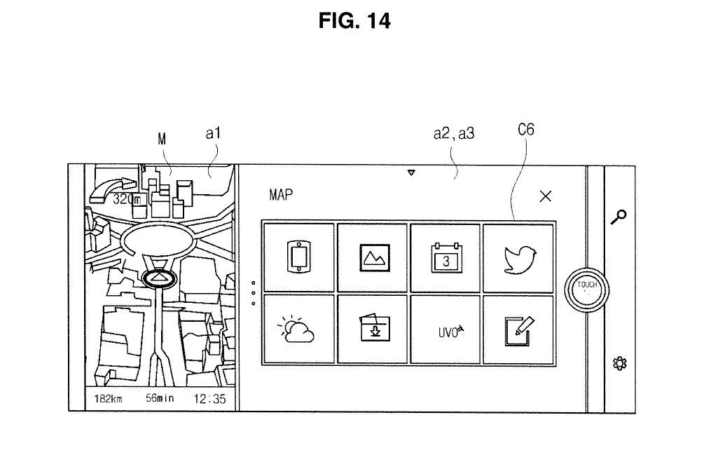

FIG. 13 is a view illustrating a display screen displayed on the touchscreen unit in the case that the application execution function of the display apparatus is performed in the external manipulation mode according to one embodiment. FIG. 14 is a view illustrating a display screen displayed on the touchscreen in the case that the application execution function of the display apparatus is performed in the touch manipulation mode according to one embodiment.

As shown in FIGS. 13 and 14, the display apparatus 10 may perform the function of executing various applications. In the external manipulation mode as shown in FIG. 13, the touchscreen 200 may display a two-dimensional or three-dimensional map M to guide a path in at least one of the sections a1 to a3, e.g., the first and second sections a1 and a2, and display a plurality of selectable menus c5 for selection from among various applications in another section, e.g., the third section a3. As described above, the selectable menus c5 for the various applications are movable up and down. The user may select and determine at least one selectable menu c5 from among the selectable menus c5 by moving the selectable menus c5.

In the touch manipulation mode as shown in FIG. 14, the touchscreen 200 may display a two-dimensional or three-dimensional map M to guide a path in at least one of the sections a1 to a3, e.g., the first section a1, and display selectable menus c6 for selection from among various applications in the other sections, e.g., the second and third sections a2 and a3. In the touch manipulation mode, the selectable menus c6 for selection from among various applications may be displayed in sections a2 and a3 larger than the section a3 in which the menus c6 are displayed in the external manipulation mode. In addition, the selectable menus c6 displayed in the touch manipulation mode may be displayed through icons larger than in the external manipulation mode.

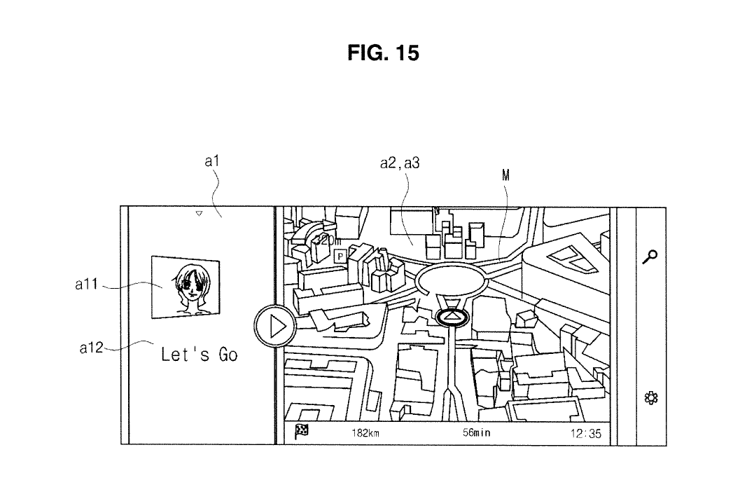

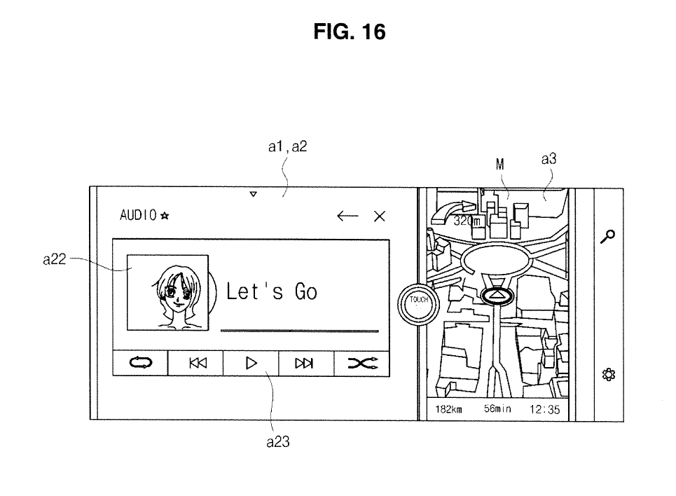

FIG. 15 is a view illustrating a display screen displayed on the touchscreen unit in the case that the sound file reproduction function of the display apparatus is performed in the external manipulation mode according to one embodiment. FIG. 16 is a view illustrating a display screen displayed on the touchscreen in the case that the sound file reproduction function of the display apparatus is performed in the touch manipulation mode according to one embodiment.

According to FIGS. 15 and 16, the display apparatus 10 may drive and execute a sound reproduction application. In this case, in the external manipulation mode as shown in FIG. 15, the touchscreen 200 may display an execution window for a sound reproduction application in at least one of the sections a1 to a3, e.g., the first section a1, and display a two-dimensional or three-dimensional map M in the other sections, e.g., the second and third sections a2 and a3. As shown in FIG. 15, only information related to sound being reproduced such as album art a11 or name a12 of a reproduced sound may be displayed in the execution window for the sound reproduction application, and function buttons for selection of stop or repetition of reproduction may not be displayed.

In the touch manipulation mode as shown in FIG. 16, the touchscreen 200 may display an execution window for a sound reproduction application in at least one of the sections a1 to a3, e.g., the first and second sections a1 and a2, and display a two-dimensional or three-dimensional map M to guide a path in the other section, such as, the third section a3. In the touch manipulation mode, the touchscreen 200 may display the execution window for the sound reproduction application in larger sections, e.g., first and second sections a1 and a2 than in the external manipulation mode. In addition to the information a22 about the reproduced sound, the touchscreen 200 may display various function buttons a23. The function buttons a23 may include a button to select stopping of reproduction, a button to select pause of reproduction, and a button to select repetition of reproduction. The user may touch the function buttons a23 to stop reproduction, pause reproduction, or repeat reproduction. In a section, such as, the third section a3 where the execution window for the sound reproduction application is not displayed, a map M may be displayed. Images for various kinds of information or selectable menus other the map M may also be displayed in the third section a3.

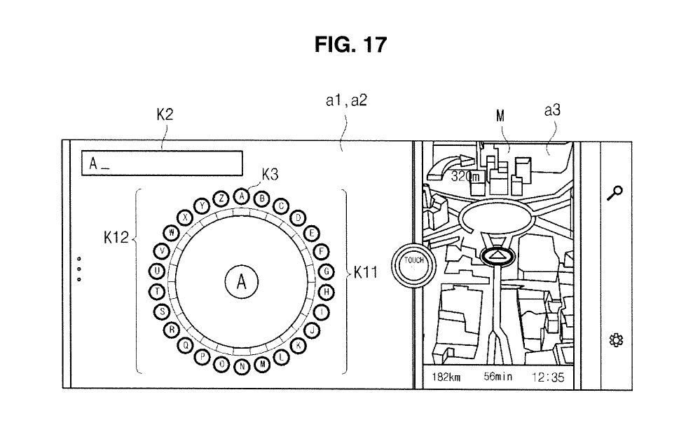

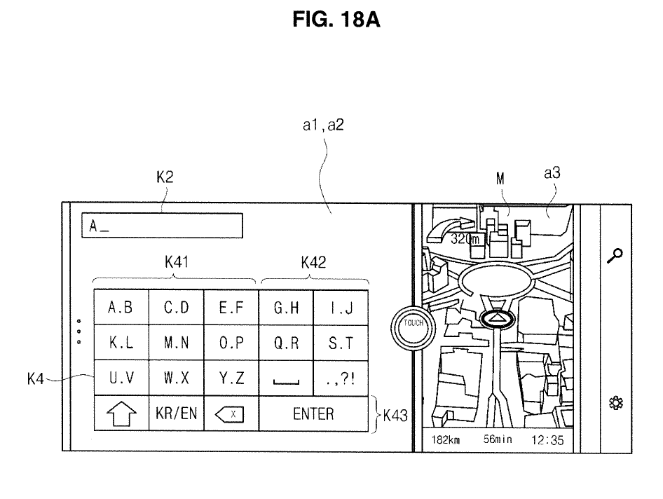

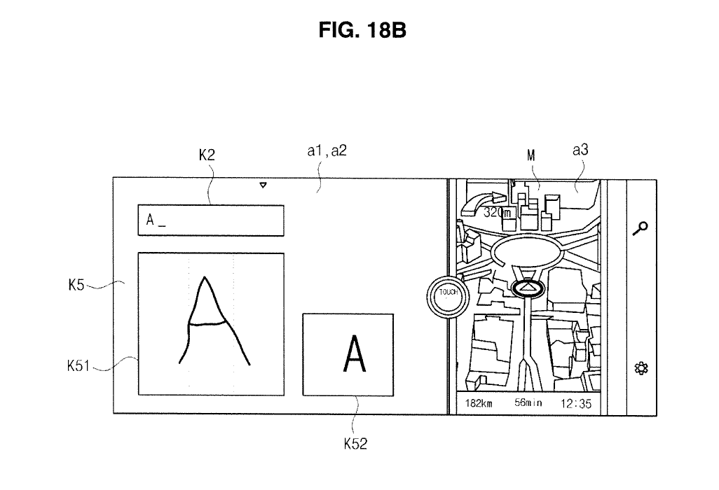

Hereinafter, a display screen displayed on the touchscreen 200 to allow input of characters in the external manipulation mode and the touch manipulation mode according to one embodiment will be described with reference to FIGS. 17, 18A, and 18B.

FIGS. 17 to 18B are views illustrating a display screen displayed to allow a convenient input of characters in the external manipulation mode and the touch manipulation mode according to one embodiment.

In the case that the touchscreen 200 displays the screen of the external manipulation mode, the screen of the external manipulation mode may include various guide images allowing the user to conveniently manipulate the input 100. For example, as shown in FIG. 17, the screen of the external manipulation mode may include a first character input image k1. The first character input image k1 may be displayed in plural sections, e.g., the first and second sections a1 and a2 of a plurality of sections partitioning the display screen a. The first character input image k1 may be displayed in a11 the sections a1 to a3. In addition, the first character input image k1 may be displayed in only one section.

The first character input image k1 may include at least one consonant input image k11 and at least one vowel input image k12. The at least one consonant input image k11 and at least one vowel input image k12 may be disposed in a circular shape on the screen. The at least one consonant input image k11 and the at least one vowel input image k12 may be displayed on circles having the same radius or may be disposed on circles having different radii.

A focus k3 may be positioned on at least one of the at least one consonant input image k11 and the at least one vowel input image k12. The user may shift the focus k3 to select at least one consonant or at least one vowel. The focus k3 may be sequentially shifted among the at least one consonant input image k11 and the at least one vowel input image k12. According to one embodiment, the focus k3 may be shifted according to manipulation of the input unit 100 by the user. For example, in the case that the input 100 is the dial manipulation device 110, when the user rotates the knob 111a, the focus k3 may be shifted by rotating in a direction corresponding to rotation of the knob 111a. When movement of the focus k3 is completed, a character, e.g., a consonant or vowel located at the position to which the focus k3 has been shifted, may be selected according to manipulation of the physical button unit 112a to 112c of the input 100. The at least one selected character may be displayed on a display bar k2 to display an input character.

In the case that the sensing unit 300 senses an object, and thus, the touchscreen 200 displays the screen of the touch manipulation mode, the screen of the touch manipulation mode may include various guide images allowing the user to conveniently perform touch manipulation. For example, the screen of the touch manipulation mode may include a second character input image k4 or a third character input image k5, as shown in FIGS. 18A and 18B. The second character input image k4 or third character input image k5 may be displayed in some sections, e.g., the first and second sections a1 and a2 of a plurality of sections partitioning the display screen a. The second character input image k4 or third character input image k5 may be displayed in a11 the sections a1 to a3. According to one embodiment, the second character input image k4 or third character input image k5 may be displayed in only one section.

Referring to FIG. 18A, the second character input image k4 according to one embodiment may include at least one button to which at least one character, at least once consonant, or at least one vowel is allocated. In this case, the at least one button may be displayed at a predetermined position on the display screen a according to a predetermined character array structure. The second character input image k4 may include at least one consonant input image k41 and at least one vowel input image k42. When necessary, the second character input image k4 may further include a predetermined function button image k43. By touching at least one button on the second character input image k4, the user may select at least one character, e.g., at least one consonant or at least one vowel, and the at least one selected character may be displayed on the display bar k2, which displays input characters.

Referring to FIG. 18B illustrating one embodiment, the third character input image k5 may include a handwriting input window k51. The handwriting input window k51 may receive handwriting input from the user. The user may use various touch tools such as a touch pen or a user's hand to input a predetermined character in the handwriting input window k51 in a handwriting manner. In this case, the controller 400 may recognize a touch gesture input through the handwriting input window k51 of the touchscreen 200, and determine which character has been input based on the recognized gesture. To determine which character has been input, the controller 400 may browse through reference data stored in the storage 500. A character which is determined to have been input by the controller 400 may be displayed on a confirmation window k52, shown in FIG. 18B. In the case that the character displayed on the confirmation window k52 is identical to the character intended by the user, the user may confirm through, for example, touch manipulation on the touchscreen 200, that the character which the controller 400 determines to have been input is a character to be input. Once the character to be input is confirmed, the confirmed character may be transferred the controller 400. In this case, a character which is currently confirmed or a character which has been previously confirmed may be displayed on the at least one display bar k2.

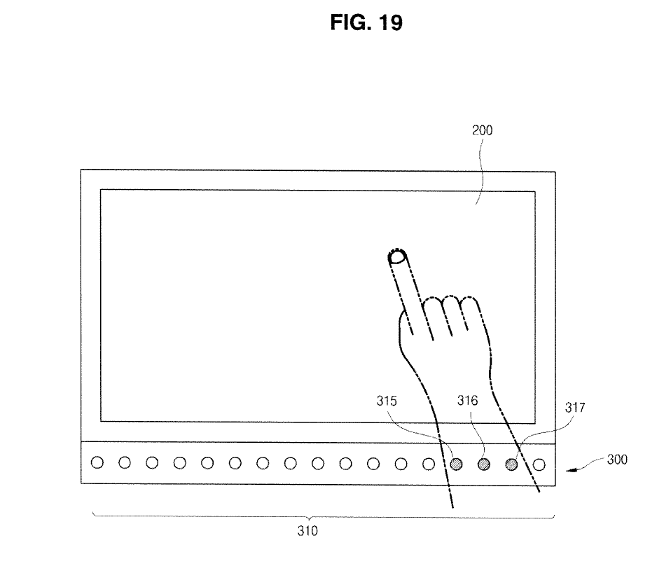

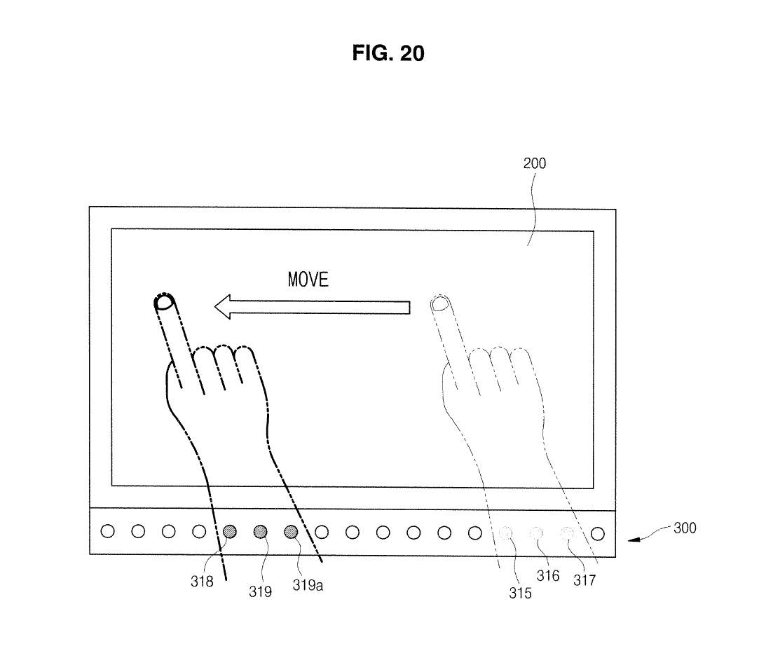

Hereinafter, an embodiment of separately setting the external manipulation mode and the touch manipulation mode according to users will be described with reference to FIGS. 19 and 20. FIGS. 19 and 20 are views illustrating a method for a sensing unit to sense users.

Referring to FIG. 19, only a few sensors 315 to 317 of a plurality of sensors 310 of the sensing unit 300 may sense an object. In this case, only the sensors 315 to 317 of the sensors 310 may output electrical signals according to sensing of an object and transfer the same to the controller 400. Then, the controller 400 may determine the locations of the sensors 315 to 317 of the sensors 310 that output the electrical signals, and then determine the direction in which the object, e.g., the user's hand has approached, according to the locations of the sensors 315 to 317 that output the electrical signals. For example, in the case that the sensors 315 to 317 of the sensors 310 that output the electrical signals are disposed near the front passenger seat, the controller 400 may determine that the object, e.g., the user's hand has reached from a location near the front passenger seat. In the case that the sensors 315 to 317 of the sensors 310 that output the electrical signals are disposed near the driver's seat, the controller 400 may determine that the object, e.g., the user's hand has reached from a location near the driver's seat.

A person may keep moving in front of the sensing unit 300 while manipulating the touchscreen 200. In this case, the plurality of sensors 315 to 319 and 319a of the sensing unit 300 may sense an object at different times and output electrical signals. The controller 400 may determine a direction in which the object moves in front of the sensing unit 300 based on the locations of the plural sensors 315 to 319 and 319a outputting the electrical signals and times at which the electrical signals have been transferred from the respective sensors 315 to 319 and 319a. Upon determining that the object moves from the sensors 315 to 317 installed near the front passenger seat to the sensors 318, 319, and 319a installed near the driver's seat, the controller 400 may determine that the object reaches from a location near the front passenger seat. On the other hand, upon determining that the object moves from the sensors 318, 319, and 319a installed near the driver's seat to the sensors 315 to 317 installed near the front passenger seat, the controller 400 may determine that the object reaches from a location near the driver's seat.

In the case that it is determined that the object reaches from a location near the driver's seat, the controller 400 may determine that the driver attempts to manipulate the touchscreen 200 and control the touchscreen 200 to display the screen of the external manipulation mode even though the sensing unit 300 has sensed the object. According to one embodiment, in the case that the vehicle is not in a traveling state, the controller 400 may control the touchscreen 200 to display the screen of the touch manipulation mode even if the object approaches from a location near the driver's seat. On the other hand, in the case that it is determined that the object approaches from a location near the front passenger seat, the controller 400 may determine that a user different from the driver attempts to manipulate the touchscreen 200, and control the touchscreen 200 to display the screen of the touch manipulation mode.

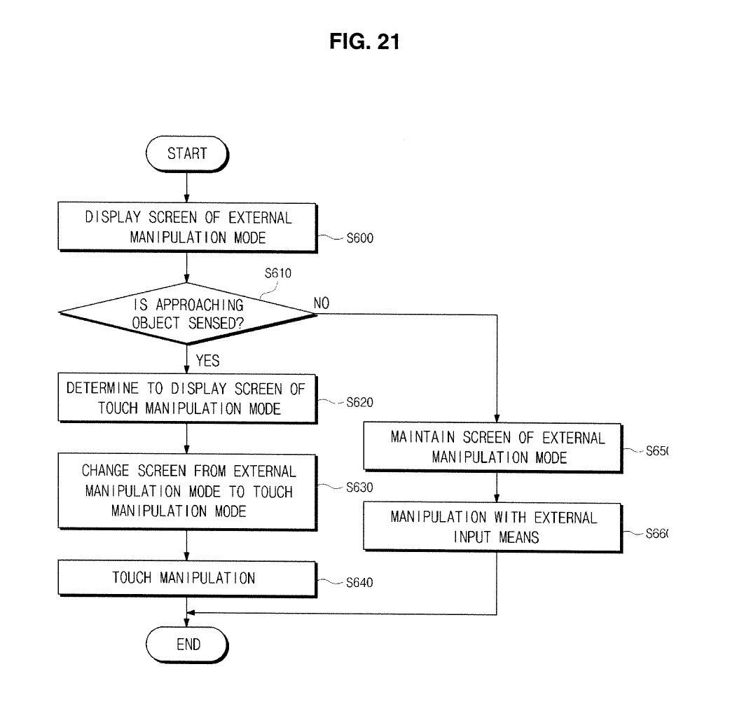

Hereinafter, a method of controlling a display apparatus according to one embodiment will be described with reference to FIG. 21. FIG. 21 is a flowchart illustrating a method of controlling a display apparatus according to one embodiment.

According to one embodiment, when power is applied to the display apparatus 10 in the vehicle, or the user manipulates a power button of the display apparatus 10 to start operation of the display apparatus 10, the screen of the external manipulation mode may be displayed on the touchscreen 200 of the display apparatus 10 as a default screen (S600). According to another embodiment, the screen of the touch manipulation mode may be displayed on the touchscreen t 200 of the display apparatus 10. In the case that the screen of the touch manipulation mode is displayed, the screen of the touch manipulation mode may be changed to the screen of the external manipulation mode when the vehicle starts traveling. According to another embodiment, when the user manipulates the input unit 100, the screen of the external manipulation mode may be displayed.

The screen of the external manipulation mode may be partitioned into a plurality of sections. In this case, a two-dimensional or three-dimensional map M may be displayed in at least two of the plurality of sections. In addition, at least one selectable menu may be displayed in at least one of the plurality of sections.

While the touchscreen 200 displays the screen of the external manipulation mode, the controller 400 may use the sensing unit 300 to determine whether an object approaching the touchscreen 200 is present (S610).

In the case that the object approaching the touchscreen 200 is present, the controller 400 may determine to display the screen of the touch manipulation mode (s620). The controller 400 may produce a predetermined control signal according to the result of determination, and transfer the produced control signal to the display part 210 of the touchscreen 200.

According to one embodiment, the controller 400 may determine whether to control the touchscreen 200 to display the screen of the touch manipulation mode or the screen of the external manipulation mode depending on whether the vehicle is traveling or whether the user is the driver.

The touchscreen 200 may display the screen of the touch manipulation mode in place of the screen of the external manipulation mode according to the received control signal (S630).

On the screen of the touch manipulation mode, a map M may be displayed in the at least one of the plurality of sections, and selectable menus may be displayed in the at least two sections of the plurality of sections. In addition, a two-dimensional map may be displayed on the screen of the touch manipulation mode to allow the user to conveniently perform touch operation. In the touch manipulation mode, the at least one selectable menu represented by button-shaped images may be displayed. In this case, the button-shaped images for the at least one selectable menu may be images created by enlarging the images displayed in the external manipulation mode. The at least one selectable menu may change depending upon content to be displayed on the screen.

With the screen of the touch manipulation mode displayed on the touchscreen 200, the user may touch various selectable buttons displayed on the screen to control the display apparatus 10 to perform a desired function (S640).

According to one embodiment, in the case that the user stops the touch manipulation on the touchscreen 200 and takes the touch tool such as the user's hand off from the touchscreen 200, the sensing unit 300 may sense that no object is present, and the controller 400 may produce a control signal according to the result of sensing by the sensing unit 300 and transfer the produced control signal to the touchscreen 200 such that the touchscreen 200 displays the screen of the external manipulation mode.

In the case that the sensing unit 300 does not sense the object approaching, the controller 400 may produce a control signal associated with maintaining the screen of the external manipulation mode and transfer the produced control signal to the touchscreen 200, or may not transfer any control signal to the touchscreen 200, such that the touchscreen 200 keeps displaying the screen of the external manipulation mode.

In this case, the user may manipulate an external input member such as the input 100 to control the display apparatus 10 (S660).

As is apparent from the above description, according to the display apparatus, a vehicle and a control method for the display apparatus described above, the display apparatus may provide a user with proper means to manipulate the display apparatus according to situation.

A driver of the vehicle may easily manipulate the display apparatus such as a navigation device safely and accurately while driving the vehicle. In addition, when the vehicle is not traveling, the driver may intuitively, promptly, and easily manipulate the display apparatus, and thus, the display apparatus may be manipulated according to the situation.

According to the display apparatus, a vehicle and a control method for the display apparatus described above, the time taken for the user to learn how to manipulate the display apparatus may be shortened, and thus, user convenience may be enhanced, and the user may receive desired information through the display apparatus when necessary.

Although a few embodiments of the present disclosure have been shown and described, it would be appreciated by those skilled in the art that changes may be made to the embodiments without departing from the principles and spirit of the invention, the scope of which is defined in the claims and their equivalents.

What is claimed is:

1. A display apparatus of a vehicle for providing various kinds of information, the display apparatus comprising:
a touchscreen to display at least one of a screen of an external manipulation mode and a screen of a touch manipulation mode; and
a sensor configured to sense an object approaching to the touchscreen,
wherein the touchscreen displays the screen of the touch manipulation mode when the sensor senses the approach of the object, and displays the screen of the external manipulation mode when the sensor does not sense the approach of the object.

2. The display apparatus according to claim 1, further comprising an input unit having at least one of a physical button unit and a knob unit, the physical button unit and knob unit configured to receive user manipulation.

3. The display apparatus according to claim 2, wherein, when the input unit is manipulated, the touchscreen displays the screen of the external manipulation mode.

4. The display apparatus according to claim 1, wherein the touchscreen displays a screen divided into a plurality of sections.

5. The display apparatus according to claim 4, wherein the touchscreen displays a map in at least two sections of the plurality of sections in the external manipulation mode, and displays the map in at least one section of the plurality of sections in the touch manipulation mode.

6. The display apparatus according to claim 5, wherein the map is a two-dimensional map or a three-dimensional map.

7. The display apparatus according to claim 6, wherein the touchscreen displays the three-dimensional map in the external manipulation mode, and displays the two-dimensional map in the touch manipulation mode.

8. The display apparatus according to claim 4, wherein the touchscreen displays at least one selectable menu in at least one section of the plurality of sections in the external manipulation mode, and displays at least one selectable menu in at least two sections of the plurality of sections in the touch manipulation mode.

9. The display apparatus according to claim 8, wherein at least one of the at least one selectable menu is selected according to at least one physical button unit and at least one knob unit in the external manipulation mode.

10. The display apparatus according to claim 4, wherein the touchscreen displays at least one scrollable selectable menu in at least one section of the plurality of sections in the external manipulation mode, or displays a plurality of selectable menus in at least one section of the plurality of sections in the touch manipulation mode.

11. The display apparatus according to claim 4, wherein the touchscreen displays information corresponding to at least one physical button in at least one section of the plurality of sections according to manipulation of the physical button.

12. The display apparatus according to claim 1, wherein the touchscreen displays at least one selectable menu represented by a button-shaped image in the touch manipulation mode.

13. The display apparatus according to claim 1, wherein the touchscreen displays a selectable menu represented by an enlarged image in the touch manipulation mode.

14. The display apparatus according to claim 1, wherein the touchscreen displays at least one different selectable menu according to content to be displayed.

15. The display apparatus according to claim 1, wherein the sensor is further configured to sense an approach direction of the object, and the touchscreen displays the screen of the touch manipulation mode according to the approach direction of the object sensed by the sensor.

16. A method of controlling a display apparatus of a vehicle for providing various kinds of information, the apparatus including a touchscreen to display at least one of a screen of an external manipulation mode and a screen of a touch manipulation mode, the method comprising steps of:
determining presence of an object; and
displaying, by the touchscreen, the screen of the touch manipulation mode upon determining that the object is present and displaying the screen of the external manipulation mode upon determining that the object is not present.

17. The method according to claim 16, wherein the step of displaying comprises displaying, by the touchscreen, the screen of the external manipulation mode when manipulation of an external input unit installed at or connected to the display apparatus is sensed.

18. The method according to claim 16, wherein at least one of the screen of the external manipulation mode and the screen of the touch manipulation mode is divided into a plurality of sections.

19. The method according to claim 18, wherein the step of displaying comprises displaying at least one selectable menu in at least one section of the plurality of sections in the external manipulation mode and displaying at least one selectable menu in at least two sections of the plurality of sections in the touch manipulation mode.

20. The method according to claim 16, wherein:
the step of determining comprises sensing an approach direction of the object; and
the screen display operation comprises displaying the screen of the touch manipulation mode according to the sensed approach direction of the object.

21. A vehicle equipped with a display apparatus for providing various kinds of information, the vehicle comprising:
a sensor configured to sense proximity of an object; and
a touchscreen to display a screen of at least one of an external manipulation mode and a touch manipulation mode, the touchscreen displaying the screen of the touch manipulation mode when the sensor senses proximity of the object.

22. The vehicle according to claim 21, further comprising a controller configured to determine whether the vehicle is traveling.

23. The vehicle according to claim 21, wherein, when the controller determines that the vehicle is traveling, the touchscreen displays the screen of the external manipulation mode.

24. The vehicle according to claim 21, wherein the sensor is further configured to sense a location of a user, and the touchscreen displays the screen of the touch manipulation mode according to the location of the user sensed by the sensor.

25. The vehicle according to claim 24, wherein the touchscreen displays the screen of the touch manipulation mode when the location of the user is near a front passenger seat.
